(19) United States
(12) Patent Application Publication
(10) Pub. No.: US 2014/0354758 A1
(43) Pub. Date: Dec. 4, 2014

(54) SYSTEM AND METHOD FOR REMOTE NOTARIZATION AND RECORDING DIGITAL NOTARY LOGBOOK ENTRIES

(71) Applicant: Christopher Spence, San Antonio, TX (US)

(72) Inventor: Christopher Spence, San Antonio, TX (US)

(21) Appl. No.: 13/975,651

(22) Filed: Aug. 26, 2013

Related U.S. Application Data
(60) Provisional application No. 61/830,166, filed on Jun. 2, 2013.

(51) Int. Cl. H04N 7/14

(52) U.S. Cl. CPC H04N 7/14
USPC 348/14.01

(57) ABSTRACT

A system and related method are disclosed for remotely notarizing a document and for recording digital notary logbook entries. A signatory records a video of a document signing on one device, and the video is conveyed to another device operated by the notary, with additional data for verification and to assist the notary. The notary notarizes the document physically or digitally, and enters a logbook entry together with the data from the signatory. Metadata including times and locations of data entry is added to the logbook data file.

### RELATED APPLICATION DATA

This application claims priority from U.S. provisional Patent Application Ser. No. 61/830,166, filed on Jun. 2, 2013, which is hereby incorporated by reference.

### TECHNICAL FIELD

Embodiments disclosed herein relate generally to document processing, and in particular to the process of remote notarization and storage of documents and related data and metadata.

### BACKGROUND ART

Authentication is the foundation of any exchange of information or agreements. A signature on a document, for instance, is only useful insofar as the time and place of the signature, and the identity of the signatory, may be trusted. A system to authenticate document signatures, as well as oaths and other legally significant transactions, is therefore essential. For many documents and transactions, that system is notarization; the document to be authenticated is signed in the presence of a neutral officer known as a notary, who verifies the signatory's identity, and signs and seals the document in turn to attest that to the time of the signature and the signatory's identity. Notarization in turn is supported by a notary's register or journal, in which the notary records detailed information concerning the notarized transaction. Properly used, such a journal enables the notary infallibly to recall whether a particular document was in fact signed in the notary's presence. The data entered into notary journals has become standardized, with only minor variations from one jurisdiction to another in the United States; typically, where laws require notaries to keep a journal, a journal entry must identify the kind of notary service, the kind of document notarized, if any, the identity of the notary's customer, how the customer identified him- or herself, and the date, time, and address, and bear the customer's signature. Some jurisdictions require additional matters to be recorded, and the notary can always record more information as a matter of routine.

Like all traditionally paper-based transactions, notarization faces a complicated and uncertain future in the face of increasingly portable and convenient communication technology. The traditional notary, who sees clients in person with a paper logbook and a stamp, will seem increasingly quaint when business meetings and court filings are taking place over the Internet, and when people increasingly expect to be able to conduct ever transaction using their mobile devices. While some attempts have been made to modernize notarization, there is still none that takes full advantage of the speed, convenience, and reliability of modern communications infrastructure.

### SUMMARY OF THE EMBODIMENTS

A method is disclosed for remotely notarizing a document. The method involves receiving, by an electronic device, from a signatory client device, signatory data including video data of a signatory signing a document, providing, by the electronic device, to a notary client device, the signatory data, receiving, by the electronic device, from the notary client device, notary data, creating, by the electronic device, a data file containing the signatory data and notary data, and embedding metadata in the data file.

In a related set of embodiments, receiving the video data also involves receiving streamed video during a video chat session. In a further embodiment, the video data includes audio data, and the method also involves automatically transcribing the audio data and extracting text data from the transcribed data. According to another embodiment, the signatory data contains personal information regarding the signatory. In an additional embodiment, the signatory data further comprises image data including an image of the document taken prior to signing, an image of the document taken after signing, an image of the signatory, and an image of an identification document identifying the signatory. In a related embodiment, receiving the image data involves extracting the image data from the video data.

In another related embodiment, receiving the notary data involves receiving, from the notary client device, an instruction electronically notarizing the image of the signed document. An additional embodiment involves providing the notarized document image to the signatory client device. The metadata includes a date and time that the signatory data was captured, according to another embodiment. Under an additional embodiment, the metadata includes the location of the signatory client device at a time when the signatory data was captured. According to another embodiment, the metadata includes a time at which the notary data was captured. In another embodiment, the metadata includes a location at which the notary data was captured.

Also claimed is a system for electronic notarization of documents. The system includes an electronic device, a signatory client device, a notary client device, a camera coupled to the signatory client device, a signatory interface component, executing on the electronic device, receiving, from the signatory client device, signatory data including video data of a signatory signing a document, a notary interface component, executing on the first electronic device, providing, to the notary client device, the signatory data, and receiving, from the notary client device, notary data, and a data file creation component, executing on the first electronic device, creating a data file containing the signatory data and notary data, and embedding metadata in the data file.

A related embodiment of the system includes a navigation facility coupled to the signatory client device. Another embodiment includes a navigation facility coupled to the notary client device. Still another embodiment includes a camera coupled to the notary client device.

Other aspects, embodiments and features of the system and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the system and method shown where illustration is not necessary to allow those of ordinary skill in the art to understand the system and method.

### BRIEF DESCRIPTION OF THE DRAWINGS

The preceding summary, as well as the following detailed description of the disclosed system and method, will be better understood when read in conjunction with the attached drawings. For the purpose of illustrating the system and method, presently preferred embodiments are shown in the drawings. It should be understood, however, that neither the system nor the method is limited to the precise arrangements and instrumentalities shown.

FIG. 1 is a flow chart illustrating one embodiment of the described method.

FIG. 2 is a schematic diagram depicting an example of an electronic device as described herein.

FIG. 3 is a schematic diagram of a network-based platform, as disclosed herein.

FIG. 4 is a block diagram depicting one embodiment of the disclosed system.

### DETAILED DESCRIPTION OF SPECIFIC EMBODIMENTS

### Definitions

As used in this description and the accompanying claims, the following terms shall have the meanings indicated, unless the context otherwise requires.

An “electronic device” is defined as including personal computers, laptops, tablets, smart phones, and any other electronic device capable of supporting an application as described herein.

A device or component is “coupled” to an electronic device if it is so related to that device that the product or means and the device may be operated together as one machine. In particular, a piece of electronic equipment is coupled to an electronic device if it is incorporated in the electronic device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the electronic device by shared membership in some network consisting of wireless and wired connections between multiple machines (e.g. a printer in an office that prints documents to computers belonging to that office, no matter where they are, so long as they and the printer can connect to the internet).

“Data entry devices” is a general term for all equipment coupled to an electronic device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure.

An electronic device's “manual data entry devices” is the set of all data entry devices coupled to the electronic device that permit the user to enter data into the electronic device using manual manipulation. Manual entry devices include without limitation keyboards, keypads, touchscreens, track-pads, computer mice, buttons, and other similar components.

An electronic device's “optical data entry devices” are components coupled to the electronic device that record images on an electronic image sensor, for instance using a digital camera, video camera, or scanner. Persons of ordinary skill in the art will be familiar with digital cameras that may be attached to computers to transfer images, cameras that operate while attached to computers (i.e. “webcams”), and the near-ubiquitous built-in cameras that come with mobile phones. Scanners that may be used with computers or other electronic devices have existed for decades, and are known to persons of ordinary skill in this invention's technical field. Furthermore, persons of ordinary skill in the art will be aware of cameras that can be attached to computers to transfer video that they have captured, digital video cameras that operate while attached to computers (i.e. “webcams”), and the digital cameras capable of capturing video that are built into many mobile phones.

An electronic device's “digital scanning devices” as used herein is a general term for all equipment coupled to an electronic device that may be used to capture and record in digital form data stored in an object not coupled to the electronic device. Digital scanning devices includes, without limitation, laser scanners or digital cameras for reading bar codes, optical scanners or digital cameras for reading QR codes or printed text, RFID readers, NFC readers, magnetic readers, and any other electrical component capable of capturing a pattern in solid shapes, variations in electromagnetic forces or radiation, variations in heat or pressure, or the output of any method for signal storage or propagation.

An electronic device's “audio data entry devices” are devices that capture sound waves and vibrations and convert them into a digital signal that may be stored and played by an electronic device. Audio data entries include, without limitation, microphones.

An electronic device's “display” is a device coupled to the electronic device, by means of which the electronic device can display images. Display include without limitation monitors, screens, television devices, and projectors.

To “maintain” data in the memory of an electronic device means to store that data in that memory in a form convenient for retrieval as required by the algorithm at issue, and to retrieve, update, or delete the data as needed.

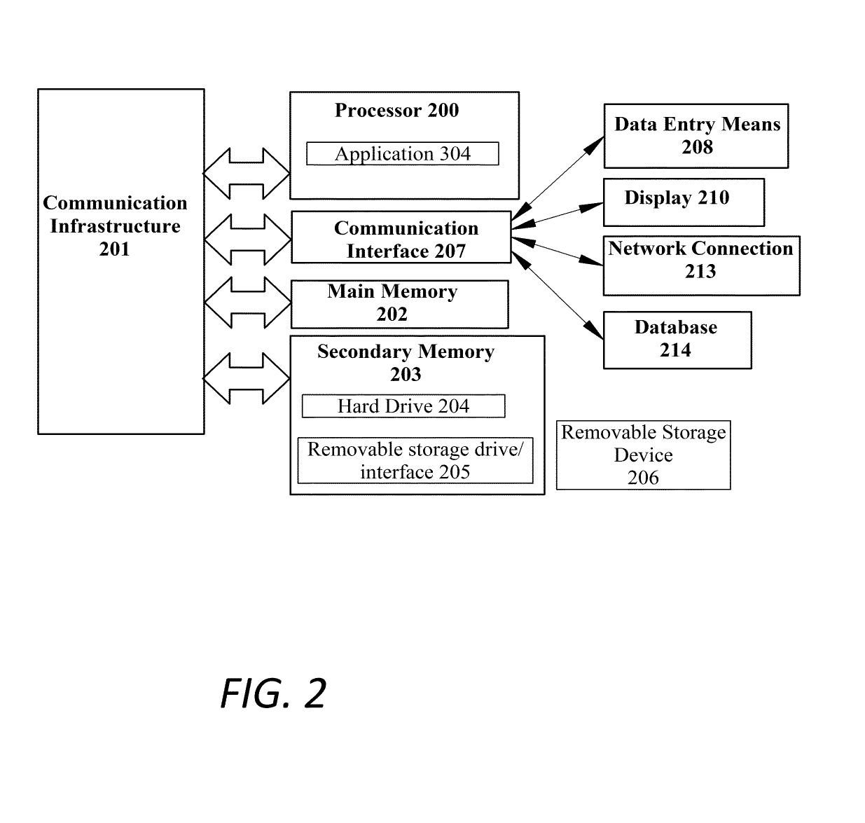

The system and method disclosed herein will be better understood in light of the following observations concerning the electronic devices that support the disclosed application, and concerning the nature of web applications in general. An exemplary electronic device is illustrated by FIG. 2. The processor 200 may be a special purpose or a general-purpose processor device. As will be appreciated by persons skilled in the relevant art, the processor device 200 may also be a single processor in a multi-core/multiprocessor system, such system operating alone, or in a cluster of computing devices operating in a cluster or server farm. The processor 200 is connected to a communication infrastructure 201, for example, a bus, message queue, network, or multi-core message-passing scheme.

The electronic device also includes a main memory 202, such as random access memory (RAM), and may also include a secondary memory 203. Secondary memory 203 may include, for example, a hard disk drive 204, a removable storage drive or interface 205, connected to a removable storage unit 206, or other similar means. As will be appreciated by persons skilled in the relevant art, a removable storage unit 206 includes a computer usable storage medium having stored therein computer software and/or data. Examples of additional means creating secondary memory 203 may include a program cartridge and cartridge interface (such as that found in video game devices), a removable memory chip (such as an EPROM, or PROM) and associated socket, and other removable storage units 206 and interfaces 205 which allow software and data to be transferred from the removable storage unit 206 to the computer system.

The electronic device may also include a communications interface 207. The communications interface 207 allows software and data to be transferred between the electronic device and external devices. The communications interface 207 may include a modem, a network interface (such as an Ethernet card), a communications port, a PCMCIA slot and card, or other means to couple the electronic device to external devices. Software and data transferred via the communications interface 207 may be in the form of signals, which may be electronic, electromagnetic, optical, or other signals capable of being received by the communications interface 207. These signals may be provided to the communications interface 207 via wire or cable, fiber optics, a phone line, a cellular phone link, and radio frequency link or other communications channels. The communications interface in the system embodiments discussed herein facilitates the coupling of the electronic device with data entry devices 208, the device's display 210, and network connections, whether wired or wireless 213. It should be noted that each of these means may be embedded in the device itself, attached via a port, or tethered using a wireless technology such as BLUETOOTH®.

Computer programs (also called computer control logic) are stored in main memory 202 and/or secondary memory 203. Computer programs may also be received via the communications interface 207. Such computer programs, when executed, enable the processor device 200 to implement the system embodiments discussed below. Accordingly, such computer programs represent controllers of the system. Where embodiments are implemented using software, the software may be stored in a computer program product and loaded into the electronic device using a removable storage drive or interface 205, a hard disk drive 204, or a communications interface 207.

The electronic device may also store data in database 212 accessible to the device. A database 212 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 212, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any device must necessarily comprise facilities to perform the functions of a processor 200, a communication infrastructure 201, at least a main memory 202, and usually a communications interface 207, not all devices will necessarily house these facilities separately. For instance, in some forms of electronic devices as defined above, processing 200 and memory 202 could be distributed through the same hardware device, as in a neural net, and thus the communications infrastructure 201 could be a property of the configuration of that particular hardware device. Many devices do practice a physical division of tasks as set forth above, however, and practitioners skilled in the art will understand the conceptual separation of tasks as applicable even where physical components are merged.

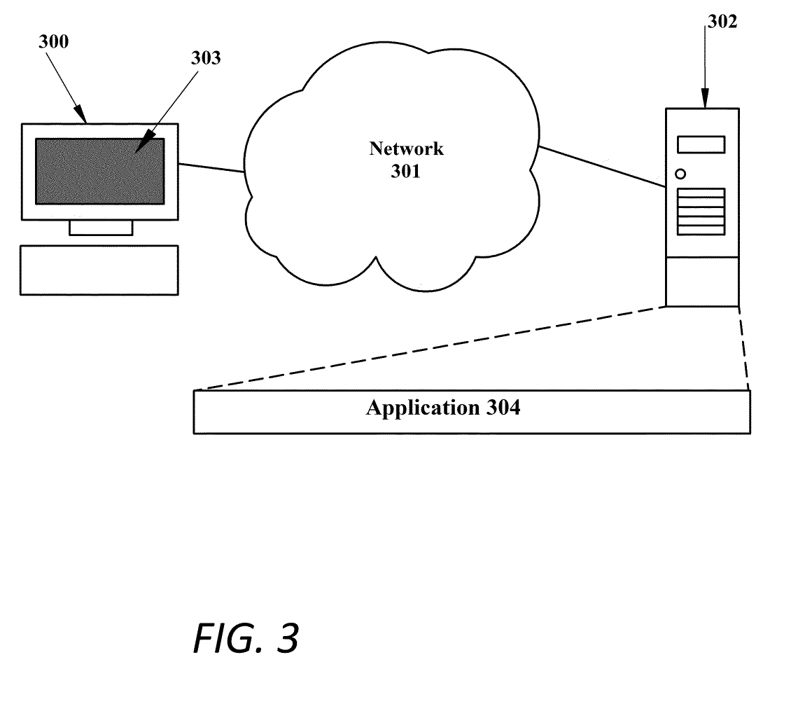

The systems may be deployed in a number of ways, including on a stand-alone electronic device, a set of electronic devices working together in a network, or a web application. Persons of ordinary skill in the art will recognize a web application as a particular kind of computer program system designed to function across a network, such as the Internet. A schematic illustration of a web application platform is provided in FIG. 3. Web application platforms typically include at least one client device 300, which is an electronic device as described above. The client device 300 connects via some form of network connection to a network 301, such as the Internet. The network 301 may be any arrangement that links together electronic devices 300, 302, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 301 is at least one server 302, which is also an electronic device as described above, or a set of electronic devices that communicate with each other and work in concert by local or network connections. Of course, practitioners of ordinary skill in the relevant art will recognize that a web application can, and typically does, run on several servers 302 and a vast and continuously changing population of client devices 300. Computer programs on both the client device 300 and the server 302 configure both devices to perform the functions required of the web application 304. Web applications 304 can be designed so that the bulk of their processing tasks are accomplished by the server 302, as configured to perform those tasks by its web application program, or alternatively by the client device 300. However, the web application must inherently involve some programming on each device.

Many electronic devices, as defined herein, come equipped with a specialized program, known as a web browser, which enables them to act as a client device 300 at least for the purposes of receiving and displaying data output by the server 302 without any additional programming. Web browsers can also act as a platform to run so much of a web application as is being performed by the client device 300, and it is a common practice to write the portion of a web application calculated to run on the client device 300 to be operated entirely by a web browser. Such browser-executed programs are referred to herein as “client-side programs,” and frequently are loaded onto the browser from the server 302 at the same time as the other content the server 302 sends to the browser. However, it is also possible to write programs that do not run on web browsers but still cause an electronic device to operate as a web application client 300. Thus, as a general matter, web applications 304 require some computer program configuration of both the client device (or devices) 300 and the server 302. The computer program that comprises the web application component on either electronic device's system FIG. 2 configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Finally, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

Aspects of the disclosed system and method allow for a signatory to obtain notarization for a signed document from any location, without having to travel to a notary's office. The notary is also freed from the need to travel, and can store accurate records of notarizations in a digital notary journal.

Some embodiments of the disclosed system and method involve live-streaming content. In some embodiments, video or audio content is live-streamed where the streaming enables the recipient to view or hear the content while the sender is still recording it. In some embodiments, live-streaming is nearly instantaneous, simulating the effect of a telephone call or an in-person conversation.

Some embodiments of the disclosed system and method involve the use of video chat sessions. A video chat session, in some embodiments, involves at least two client devices as described above in reference to FIG. 3, each of which receives video data via optical data entry devices, and simultaneously transmits that video data to the other client device. Each client device 300 may also use incorporated audio data entry devices to capture and transmit audio data simultaneously with the video data. As a result, the user of each client device 300 is immediately able to see the video captured by the camera connected to the other client device 300. This process enables users to engage in a conversation that simulates face-to-face conversation, via two-way video communication.

Some embodiments of the disclosed system and method involve the manipulation of signatory data. “Signatory data” in some embodiments is any data that is provided by a signatory pursuant to a service performed by a notary in his or her capacity as a notary. A “signatory” may be any person seeking notary services, including a person with who needs a document signature notarized, or a witness to the signing or notarization. Signatory data may include anything that would traditionally be entered in a notary journal or a notarized document by a signatory, according to custom or by law, such as the printed name of the signatory, the signature of the signatory, the signatory's complete address, the type of proof of identification presented by the signatory, the identification number if any on the identification means presented, the type of notarial act performed on the instant occasion, the type of document notarized if any, the date of any notarized document, whether witnesses were present for the instant notarization, whether other signatories were present; the name, address, and signature of any witness, any additional comments the signatory wishes entered concerning the notarial transaction, and any biometric data entered by the signatory, such as a fingerprint or thumbprint.

Some embodiments of the disclosed system and method involve the manipulation of notary data. “Notary data” in some embodiments is any data that concerns a service performed by a notary in his or her capacity as a notary. Notary data may include anything that would traditionally be entered in a notary journal or on a document by a notary in accordance with custom or by law, such as the printed name of the notary, the signature of the notary, the time and date of the service performed by the notary, the signatory's complete address, the type of proof of identification presented by the signatory, the identification number if any on the identification means presented, the type of notarial act performed on the instant occasion, the fee charged by the notary for the service, the type of document notarized if any, the date of any notarized document, whether witnesses were present for the instant notarization, whether other signatories were present; the name, address, and signature of any witness, additional comments concerning the transaction, reason for failure or refusal of notarization if the notarization was not completed, and the fingerprint or thumbprint of the signatory. Notary data may also include the signature of the notary. Notary data may include the jurat of the notary. Notary data may include the seal of the notary.

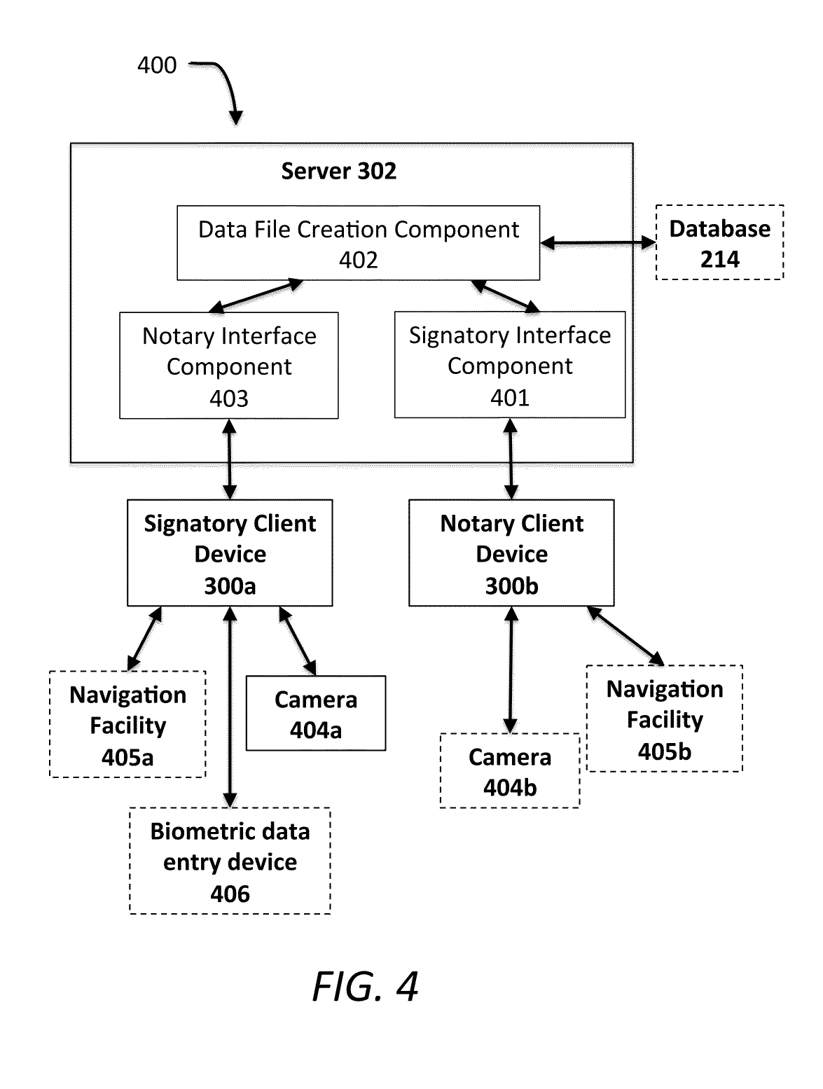

FIG. 4 illustrates some embodiments of the disclosed system 400. The system 400 comprises a server 302, a signatory client device 300a and a notary client device 300b. The server 302 is configured to perform tasks. So much of the electronic device as is configured to perform the tasks may be conceptually divided into a signatory interface component 401, a data file creation component 402, and a notary interface component 403. The organization of tasks into those three components solely reflects a categorization of the tasks to be performed, and does not dictate the architecture of particular implementations of the system 400. The signatory client device 300a is coupled to a camera 404a.

The system 400 includes a server 302. In some embodiments the server 302 is as server 302 as set forth above in reference to FIG. 3. The server 302 communicates in some embodiments with a signatory client device 300a via a network (not shown) as described above in reference to FIGS. 2 and 3. In some embodiments, the signatory client device 300a is a client device 300 as described above in reference to FIG. 3. The signatory client device 300a is coupled to a camera 404a in some embodiments. The camera 404a may include any optical data entry device described above that can capture video data. The camera 404a may also include audio data entry devices. In some embodiments, the system 400 includes a navigation facility 405a coupled to the signatory electronic device 300a. In some embodiments, a “navigation facility” is any facility coupled to an electronic device that enables the device accurately to calculate the device's location on the surface of the Earth. Navigation facilities may include a receiver configured to communicate with the Global Positioning System or with similar satellite networks, as well as any other system that mobile phones or other devices use to determine their location, for example by communicating with cell towers. In some embodiments, the signatory client device 300a is coupled to a biometric data entry device 406. A biometric data entry device in some embodiments is a data entry device that records biometric data. “Biometric data” may be any physiological data that uniquely identifies a person. Biometric data includes without limitation fingerprints, thumbprints, retinal scans, facial features amenable to recognition by facial recognition systems, and Deoxyriboneucleic acid (DNA) profiles. Biometric data entry devices include without limitation fingerprint scanners, handprint scanners, retinal scanners, voice-recognition systems, and facial recognition systems. A biometric data entry device may also be an optical data entry device, such as a camera 404a, combined with a computer program executing on an electronic device coupled to the optical data entry device, and operable to isolate biometric data such as fingerprints, as set forth in more detail below.

In some embodiments, the server 302 communicates with a notary client device 302b via a network (not shown) as described above in reference to FIGS. 2 and 3. The notary client device 300b in some embodiments is a client device as described above in reference to FIG. 3. The notary client device 300b is coupled to a camera 404b in some embodiments. The camera 404b may include any optical data entry device described above that can capture video data. The camera 404b may also include audio data entry devices. In some embodiments, the system 400 includes a navigation facility 405b coupled to the notary electronic device 300a.

In some embodiments, the signatory interface component 401 is created on the server 302 by means of computer programs as described above in reference to FIGS. 2 and 3. In some embodiments, the data file creation component 402 is created on the first server 302 by means of computer programs as described above in reference to FIGS. 2 and 3. The data file creation component 402 in some embodiments communicates with a database 212. The database 212 may be any database as described above in reference to FIG. 2. In some embodiments, the notary interface component 403 is created on the first server 302 by means of computer programs as described above in reference to FIGS. 2 and 3.

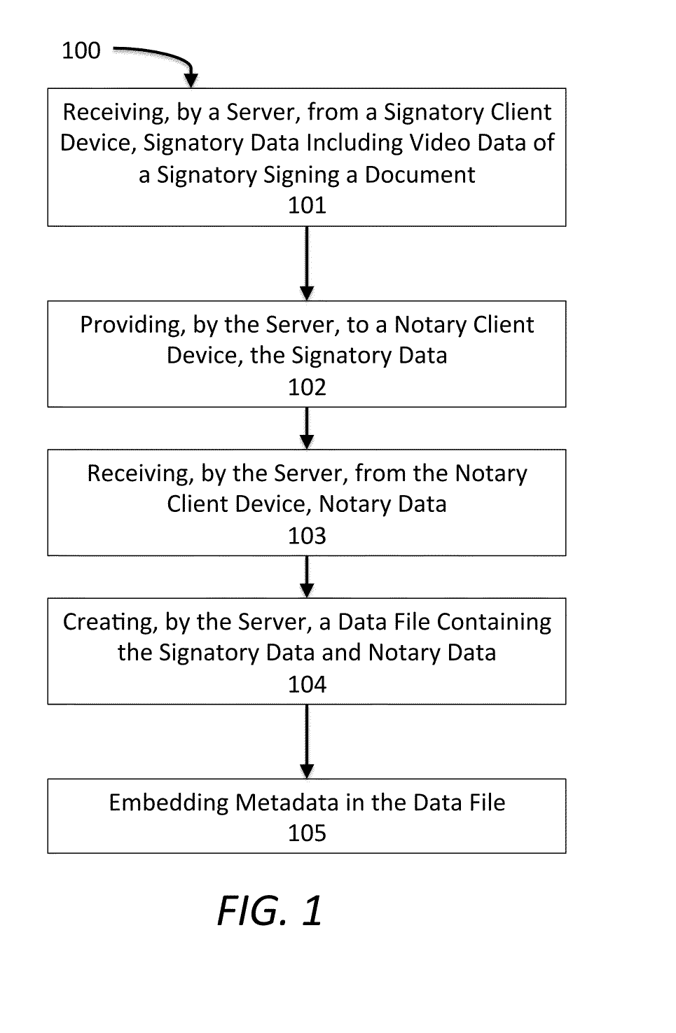

FIG. 1 illustrates some embodiments of the disclosed method 100. The method 100 includes receiving, by server, from a signatory client device, signatory data including video data of a signatory signing a document (101). In addition, the method 100 includes providing, by the server, to a notary, the signatory data (102). The method 100 further includes receiving, by the server, from the notary client device, notary data (103). The method 100 additionally includes creating, by the server, a data file containing the signatory data and notary data (104). The method 100 further includes embedding metadata in the data file (105).

More particularly, and with reference to FIG. 4, the method 100 includes receiving, by an electronic device, from a signatory client device, signatory data including video data of a signatory signing a document (101). The signatory data may be captured by a program provided by the signatory interface component 401 and executing on a web browser on the signatory client device 300a. The signatory data may be captured by the signatory interface component 401 by accepting input from a program executing on the signatory client device 300a. The signatory data may be captured using an application executing on the signatory client device 300a. The signatory data may be retrieved from the memory of the signatory client device 300a. The signatory data may be retrieved from an additional device (not shown) by the signatory client device 300a; for example, the signatory client device 300a may obtain some of the signatory data via the Internet from a server. The server 302 may retrieve the signatory data from an additional device (not shown); for example, the server 302 may obtain some of the signatory data via the Internet from another server. In some embodiments, the signatory client device 300a records the video data via the camera 404a. Video data in some embodiments also includes audio data simultaneously recorded using audio input devices (not shown) coupled to the signatory client device 300a. In some embodiments, where the video data includes audio data, the signatory interface component 401 also receives signatory data by automatically transcribing the audio data and extracting text data from the transcribed data. In some embodiments, the signatory interface component 401 includes an algorithm to convert audio data containing speech into textual data.

The signatory client device 300a may send the video data to the signatory interface component 401 using any protocol effective for transmitting video files over a network. For example, the video data may be transmitted via file transfer protocol (FTP). The video data may be transmitted via an electronic mail (email) protocol such as simple message transfer protocol (SMTP). The video data may be streamed from the signatory client device 300a to the signatory interface component 401. The video data may be live-streamed from the signatory client device 300a to the signatory interface component 401. The signatory interface component 401 may provide a video capture program that operates on a web browser executing on the signatory client device 300a. The signatory interface component 401 may provide a video capture program that operates on the server 302 and accepts video data streamed from the signatory client device 300a. Alternatively, the signatory interface component 401 may accept video data captured by an application that executes on the signatory client device 300a.

In some embodiments, the notary provides the signatory with instructions to follow while recording the video data. The notary may provide the instructions as text. The notary may provide the instructions in image form. The notary may provide the instructions in audio form; for instance, the notary may speak into an audio data entry device (not shown) coupled to the notary client device 300b, which instructions the server 302 provides via the signatory client device 300a to the signatory. The notary may provide the instructions in video form; for instance, the notary may cause the instructions to be captured by a camera 404b coupled to the notary client device 300b, which instructions the server 302 provides via the signatory client device 300a to the signatory. The notary may provide the instructions concerning the recording of the video data. As an example, the notary may record a video tutorial prior to the signing of the document explaining to the signatory in what order and how to perform each step in recording the document signing. The notary may provide the instructions during the document signing. For example, the notary may send a new text instruction after each step in the signing process is completed. In some embodiments, the notary provides instructions to the signatory during a video chat session. In some embodiments, the signatory interface component 401 receives the video data by receiving streamed video. In some embodiments, the signatory interface component 401 receives the video data by receiving streamed video during a video chat session.

In some embodiments, the notary instructs the signatory to make statements as required by regulation; for instance, the notary may request the signatory to hold the document up so that its contents are visible in the video. In some embodiments, the notary may request that the signatory display each page to the camera 404a in turn, so that the notary is aware of the document contents. The notary may also request that the signatory keep the document visible at all times, so that the notary can ascertain that the displayed document is the same the signatory signs. In some embodiments, the notary may instruct the signatory to display each page of the document to the camera 404a in turn after signing. In some embodiments, the notary interface component 403 receives an instruction from the notary canceling the transaction. For example, the notary may enter the instruction if the signatory fails to follow the notary's directions while producing the video data. In some embodiments, the data file creation component 402 records the notary's cancelation instruction in the data file. In some embodiments, the notary's cancelation instruction includes reasons for cancelation.

In some embodiments, the signatory data further includes personal information regarding the signatory. In some embodiments, the signatory interface component 401 receives the personal information in the form of text input via manual data entry devices (not shown) coupled to the signatory client device 300a. For example, the signatory interface component 401 may provide one or more text data entry fields to that displays via a web browser executing on the signatory client device 401. Alternatively, the signatory interface component 401 may accept textual data from one or more text entry fields in the user interface of an application that executes on the signatory client device 300a. In some embodiments, the signatory interface component 401 directs the signatory to open an account by entering personal information. The account may be stored in memory accessible to the server 302. The account may be stored in a database 212 accessible to the server 302. The signatory may open the account prior to the capture of the video data. The signatory may open the account during the capture of the video data. The signatory may open the account after the capture of the video data. In some embodiments, the signatory interface component 401 automatically transcribes the personal information from audio data included in the video data.

In some embodiments, the signatory data also includes image data including an image of the document taken prior to signing, an image of the document taken after signing, an image of the signatory, and an image of an identification document identifying the signatory. In some embodiments, the signatory interface component 401 receives the image data by extracting the image data from the video data.

In some embodiments, the signatory data further includes biometric data. In some embodiments, the signatory client device 300a captures the biometric data using a biometric data entry device 406. In some embodiments, the signatory client device 300a captures the biometric data using an optical data entry device, such as the camera 404a. For example, and without limitation, the signatory client device 300a may capture a fingerprint or thumbprint using the camera 404a by capturing an image of an object bearing the finger or thumbprint with the digital camera 404a. The object may be a sheet of paper. The finger or thumbprint may be applied to the object using ink, such as the ink typically used to take finger or thumbprints. In some embodiments, the fingerprint or thumbprint is applied to the object while the video data is being captured, and the object is positioned for image capture, and the image captured, without breaking the visibility of the object for the capture of video data. In some embodiments, the image of the object bearing the print is captured by extrapolating a still image from the video data. The signatory client device 300a may perform the extrapolation. The signatory interface component 401 may perform the extrapolation. In some embodiments, the image of the print is extracted from the captured image. The signatory client device 300a may extract the print image. The signatory interface component 401 may extract the print image. In some embodiments, the print image is extracted by converting the image of the object to a binary dichromatic form, in which only features of the print are in a contrast color; for instance, if the object is a white sheet of paper, and the print is in black ink, all non-white color in the picture is rendered in the dichromatic image as black, and all black pixels are extracted as print image.

In some embodiments, the print image is saved only upon determination that it is of sufficient quality. In some embodiments, the determination of sufficient quality is accomplished by receiving an instruction from a user indicating that the print is of sufficient quality based upon visual inspection. The user may be the notary. The notary interface component 403 may receive the instruction. In some embodiments, a computer program determines the quality level of the print. The computer program may execute on the signatory client machine 300a. The computer program may execute on the notary client machine 300b. The computer program may execute on the server 302. In some embodiments, the computer program compares shapes in the print image to statistical rules concerning prints; for instance, a print feature that has too great a surface area in the print image may be interpreted as a smudge, indicating an insufficient degree of quality. In some embodiments, the determination of quality is made both by a computer program and by a user. As an example, the computer program may initially determine that the print is of good quality, and the notary may review the print visually to verify that determination. In other embodiments, an analogous process is performed using an image of a bodily feature of the signatory, such as a finger or thumb.

In some embodiments, the signatory data includes a signature from the signatory. The signature may be captured by optical data entry device, such as the camera 404a, coupled to the signatory client device 300a. In some embodiments, the signatory signs an object, and the optical data entry device captures the image of that object. In some embodiments, the image of the signature itself is extracted from the image of the object. The signatory client device 300a may perform the extraction. The notary client device 300b may perform the extraction. The server 302 may perform the extraction. In some embodiments, a manual data entry device (not shown) coupled to the signatory client device 300a captures the signature. The signatory may sign on a signature tablet. The signatory may sign on a touchscreen. The signatory may sign on a track-pad.

In addition, the method 100 includes providing, by the electronic device, to a notary client device, the signatory data (102). The notary interface component 404 may display to the notary a representation of the signatory data. The representation of the signatory data may summarize the contents of the signatory data. The representation of the signatory data may provide the notary with the ability to view the contents of the signatory data in more detail. For instance, each datum in the signatory data may be summarized by a link, which the notary can select using manual data entry devices to cause that datum to display. Each datum in the signatory data may be summarized by a button, which the notary can select using manual data entry devices to cause that datum to display. As a further example, the notary may select a representation summarizing the video data, causing the video data to play on a display coupled to the notary client device 300b. The notary interface component 403 may provide the notary with controls permitting the user to control the video play. The controls may include a pause control. The controls may include a rewind control. The controls may include a fast-forward control. The controls may include a zoom control that permits the notary to zoom in on a portion of the display screen.

In some embodiments, the notary interface component 403 displays the video data by live-streaming the video data to the notary client device 403. In some embodiments, the notary interface component 403 displays the video data to the notary during a video chat session. The notary may also cause video data to stream to the signatory client device 300a during the video chat session, for example capturing the video data using a camera 404b coupled to the notary client device 300b. Video data in some embodiments also includes audio data simultaneously recorded using audio input devices (not shown) coupled to the notary client device 300b.

The method 100 further includes receiving, by the electronic device, from the notary client device, notary data (103). The notary data may be captured by a program provided by the notary interface component 403 and executing on a web browser on the notary client device 300b. The notary interface component 403 may receive the notary data by accepting input from a program executing on the notary client device 300b that captures the notary data. The notary data may be captured using an application executing on the notary client device 300b. The notary data may be retrieved from the memory of the notary client device 300b. The notary data may be retrieved from an additional device (not shown) by the notary client device 300b; for example, the notary client device 300b may obtain some of the signatory data via the Internet from a server. The notary interface component 403 may receive the notary data via data entry devices coupled to the notary client device 300b. The notary interface component 403 may receive the notary data via manual data entry devices (not shown) coupled to the notary client device 300b. The notary interface component 403 may receive the notary data via optical data entry devices, such as a camera 404b. The notary interface component 403 may receive the notary data via audio data entry devices (not shown). In some embodiments, the notary interface component 403 receives notary data before the signatory interface component 401 receives the video data. In some embodiments, the notary interface component 403 receives notary data while the signatory interface component 401 receives the video data. In some embodiments the notary interface component 403 receives notary data after the signatory interface component 401 receives the video data.

In some embodiments, the notary interface component 403 receives the notary data by receiving, from the notary client device, an instruction electronically notarizing the image of the signed document. The notarization entered may include a signature. The notarization entered may include a jurat. The notarization entered may include a seal. In some embodiments, the notary interface component 403 accepts the notarization via manual data entry devices (not shown) coupled to the notary client device 300b. The notarization may be typed; for example, a signature included in the notarization may be entered according to an agreed-upon convention for typed signature representation. In some embodiments, a manual data entry device captures a notary signature included in the notarization when the notary signs the device. The notary may sign on a signature tablet. The notary may sign on a touchscreen. The notary may sign on a track-pad. In some embodiments, a manual data entry device captures a notary seal included in the notarization when the notary applies a physical seal, such as a stamp, to the device. The notary may apply the seal to a signature tablet. The notary may apply the seal to a touchscreen. The notary may apply the seal to a track-pad. In some embodiments, a manual data entry device captures a jurat when the notary applies the jurat with a physical object, such as a stamp, to the device. The notary may apply the physical object to a signature tablet. The notary may apply the physical object to a touchscreen. The notary may apply the physical object to a track-pad.

In some embodiments the notary applies the notarization to a physical object, and an optical data entry device, such as a camera 404b, coupled to the notary client device 300b captures the image of the physical notarization. The physical notarization may be on a document. In some embodiments, the notary client device 300b combines the captured notarization with the image of the document to be notarized. In some embodiments, the notary interface component 403 combines the captured notarization with the image of the document to be notarized. In some embodiments, the notary prints out the document to be notarized, notarizes the printed document, and instructing the notary client device 300b to capture the image of the notarized document using optical data entry devices. The signatory interface component 401 may provide the notarized document image to the signatory client device 300a.

The method 100 additionally includes creating, by the electronic device, a data file containing the signatory data and notary data (104). In some embodiments, the data file creation component 402 accepts the notary data from the notary client device 300b via the notary interface component 403, accepts the signatory data from the signatory client device 300a via the signatory interface component 401, assembles the signatory data and notary data together, and creates a data file storing the assembled data. In some embodiments, the notary client device 300b assembles signatory data and notary data and transmits the assembled data via the notary interface component 403 to the data file creation component 402, which creates the data file using the assembled data. In some embodiments, the signatory client device 300a assembles signatory data and notary data and transmits the assembled data via the signatory interface component 401 to the data file creation component 402, which creates the data file using the assembled data. In some embodiments, the data file creation component 402 maintains the data file in memory accessible to the server 302. In some embodiments, the data file creation component 402 maintains the data file in a database 212 accessible to the server 302.

The method 100 further includes embedding metadata in the data file (105). In some embodiments, the data file creation component 402 embeds the metadata in the data file by adding the metadata to the data file. In some embodiments, the data file creation component 402 overwrites the data file with a new data file containing the data from the original data file as well as the metadata. In some embodiments, the notary client device 300b adds metadata to a file on the notary client device 300b that includes the data contained in the data file, and transmits it via the notary interface component 403 to the data file creation component 402, which overwrites the previous data file with the transmitted data file. In some embodiments, the signatory client device 300a adds metadata to a file on the notary client device 300a that includes the data contained in the data file, and transmits it via the signatory interface component 401 to the data file creation component 402, which overwrites the previous data file with the transmitted data file. In some embodiments, the signatory client device 300a creates the metadata. In some embodiments, the notary client device 300b creates the metadata. In some embodiments, the server 302 creates the metadata. In some embodiments, the electronic device receives the metadata via a network from an additional electronic device (not shown).

In some embodiments, the metadata includes a date and time that the signatory data was captured. In some embodiments, the metadata includes the date and time that the video data was captured. The metadata includes the location of the signatory client device 300a at a time when the signatory data was captured, in some embodiments. In some embodiments, the metadata includes the location of the signatory client device 300a at the time the custom data file was created. The signatory client device 300a may determine its location using a navigation facility 405a coupled to the signatory client device 300a. The signatory interface component 401 may receive the location information from the signatory client device 300a. In some embodiments, the data file creation component 402 uses information concerning the signatory client device 300a to determine its location. For example, the signatory interface component 401 may receive data describing a telecommunications link by means of which the signatory client device 300a communicates. The telecommunications link may be the cell tower nearest to the signatory client device 300a. The telecommunications link may be a set of cell towers nearest to the signatory client device 300a. The telecommunications link may be the physical address of a modem by means of which the signatory client device 300a communicates with the electronic device 401.

In some embodiments, the metadata includes a time at which the notary data was captured. In additional embodiments, the metadata includes a location at which the notary data was captured. In some embodiments, the metadata includes the location of the notary client device 302b at the time the custom data file was created. The notary client device 300b may determine its location using a navigation facility 405b coupled to the notary client device 300b. The notary interface component 403 may receive the location information from the notary client device 300b. In some embodiments, the data file creation component 402 uses information concerning the notary client device 300b to determine its location. For example, the notary interface component 403 may receive data describing a telecommunications link by means of which the notary client device 300b communicates. The telecommunications link may be the cell tower nearest to the notary client device 300b. The telecommunications link may be a set of cell towers nearest to the notary client device 300b. The telecommunications link may be the physical address of a modem by means of which the notary client device 300b communicates with the electronic device 401.

In some embodiments, the data file creation component 402 makes the data file read-only. In some embodiments, the data file becomes read-only at different points with respect to different users. The data file creation component 402 may make the data file read-only with respect to the signatory after accepting the signatory data. The data file creation component 402 may make the data file read-only with respect to the notary after accepting the notary data. In some embodiments, the data file creation component 402 renders some portions of the data file read-only with respect to all users. For example, the metadata may be read-only with respect to all users.

It will be understood that the system and method may be embodied in other specific forms without departing from the spirit or central characteristics thereof. The present examples and embodiments, therefore, are to be considered in all respects as illustrative and not restrictive, and the system method is not to be limited to the details given herein.

What is claimed is:

1. A method for remotely notarizing a document, the method comprising:
receiving, by a server, from a signatory client device, signatory data including video data of a signatory signing a document;
providing, by the server, to a notary client device, the signatory data;
receiving, by the server, from the notary client device, notary data;
creating, by the server, a data file containing the signatory data and notary data; and
embedding metadata in the data file.

2. A method according to claim 1, wherein receiving the video data further comprises receiving streamed video during a video chat session.

3. A method according to claim 1, wherein the video data includes audio data, and further comprising:
1. automatically transcribing the audio data; and
2. extracting text data from the transcribed data.

4. A method according to claim 1, wherein the signatory data further comprises personal information regarding the signatory.

5. A method according to claim 1, wherein the signatory data further comprises image data including an image of the document taken prior to signing, an image of the document taken after signing, an image of the signatory, and an image of an identification document identifying the signatory.

6. A method according to claim 5, wherein receiving the image data comprises extracting the image data from the video data.

7. A method according to claim 5, wherein receiving the notary data further comprises receiving, from the notary client device, an instruction electronically notarizing the image of the signed document.

8. A method according to claim 7, further comprising providing the notarized document image to the signatory client device.

9. A method according to claim 1, wherein the metadata includes a date and time that the signatory data was captured.

10. A method according to claim 1, wherein the metadata includes the location of the signatory client device at a time when the signatory data was captured.

11. A method according to claim 1, wherein the metadata includes a time at which the notary data was captured.

12. A method according to claim 1, wherein the metadata includes a location at which the notary data was captured.

13. A system for electronic notarization of documents, the system comprising:
a server;
a signatory client device;
a notary client device;
a camera coupled to the signatory client device;
a signatory interface component, executing on the server, receiving, from the signatory client device, signatory data including video data of a signatory signing a document;
a notary interface component, executing on the server, providing, to the notary client device, the signatory data, and receiving, from the notary client device, notary data; and
a data file creation component, executing on the server, creating a data file containing the signatory data and notary data, and embedding metadata in the data file.

14. A system according to claim 14, further comprising a navigation facility coupled to the signatory client device.

15. A system according to claim 14, further comprising a navigation facility coupled to the notary client device.

16. A system according to claim 14, further comprising a camera coupled to the notary client device.
